(19) United States
(12) Patent Application Publication
(10) Pub. No.: US 2014/0218771 A1
(43) Pub. Date: Aug. 7, 2014

(54) SCANNING DOCUMENTS USING ENVELOPES AS DOCUMENT SEPARATORS

(71) Applicant: XEROX CORPORATION, Norwalk, CT (US)

(72) Inventors: Rakesh S. Kulkarni, Webster, NY (US); Robert J. St. Jacques, Fairport, NY (US)

(73) Assignee: XEROX CORPORATION, NORWALK, CT (US)

(21) Appl. No.: 13/761,737

(22) Filed: Feb. 7, 2013

(51) Int. Cl. H04N 1/21

(52) U.S. Cl. CPC H04N 1/2166
USPC 358/403

(57) ABSTRACT

Methods and systems remove sheets of media from envelopes, and scan the envelopes and the sheets of media through an optical scanner. Such method and systems use the envelopes as separator sheets between groups of the sheets of media. During the scans each envelope is followed by a corresponding group of sheets of media that were within the envelope when the envelope was received. Further, the exterior of each envelope comprises classification data that classifies the corresponding group of the sheets of media. Such methods and systems produce electronic scan documents of scans of the groups of sheets separated according to the envelopes that act as the separator sheets. The electronic scan documents and the classification data can then be automatically provided to an electronic records system. The electronic records system automatically processes the electronic scan documents using the classification data.

### BACKGROUND

Systems and methods herein generally relate to optical scanning systems, and more particularly relate to processing items that are removed from envelopes to be scanned within computerized electronic record systems.

Many industries use computerized record keeping systems. One example of a computerized record keeping system discussed herein is Electronic Medical Record (EMR)/Electronic Health Record (EHR) systems. While EMR/EHR systems are discussed as an example at different points in this disclosure, the systems and methods herein are not limited to EMR/EHR systems, but instead are useful in all computerized record keeping systems.

In one example, small and medium healthcare businesses handle large amounts of incoming mail (from payers, labs, specialists, other clinics, patients, etc). Much of this mail is opened and scanned into the Electronic Medical Record (EMR)/Electronic Health Record (EHR) systems for the appropriate patient. While all EMR/EHR systems provide some support for receiving scanned documents, the support for scanning batch jobs varies wildly from one system to another. While some EMR/EHR systems allow users to manually separate or combine digital documents (i.e. from a batch scan), others do not, requiring a cumbersome, manual scan process where multi-page documents are scanned one at a time. Such small medical providers cannot afford elaborate solutions, which can cause staff, that would otherwise be occupied by more important value-added tasks, to waste time manually scanning documents.

Small and medium businesses cannot afford expensive solutions for their incoming mail. Due to the variety of incoming mails, they cannot afford to pay a third party company and outsource the mailroom process. At the same time, such small business may receive a significant amount of hard copy mail from various partners including smaller insurance companies, clinics, clients, specialists, labs, etc. Even a paperless office must still deal with paper correspondence from other facilities that are not.

In the medical office example, much of the hard copy mail that arrives at the office must be scanned into the EMR/EHR where it is later processed (e.g. attached to a patient record and/or acknowledged by a healthcare provider). The task of getting the paper mail into the EMR/EHR is such a time intensive task that it is not uncommon for healthcare providers to employ a “document manager,” a person that spends all or part of their time simply converting paper information into digital. This staff often is overqualified for the job, and could be far better used on other tasks more closely related to the core business.

### SUMMARY

One exemplary method or workflow herein receives envelopes containing sheets of media, removes the sheets of media from the envelopes, and scans the envelopes and the sheets of media through an optical scanner. The envelopes have a size capable of being scanned by the optical scanner. This method uses the envelopes as separator sheets between groups of the sheets of media. In some embodiments, each envelope comprises a unique marking on the exterior that identifies the envelope as a separator sheet.

During the scans each envelope is followed by a corresponding group of sheets of media that were within the envelope when the envelope was received. Further, the exterior of each envelope comprises classification data that classifies the corresponding group of the sheets of media. The classification data can, for example, comprises handwritten, typed, or printed marks on the exterior of the envelopes.

This exemplary method automatically produces electronic scan documents of scans of the groups of sheets separated according to the envelopes that act as the separator sheets. Thus, each of the electronic scan documents comprises a scan of a different one of the groups of the sheets of media. The electronic scan documents and the classification data can then be automatically provided to an electronic records system using a computerized device.

The electronic records system automatically processes the electronic scan documents using the classification data. For example, the electronic records system can use the classification data to sort the electronic scan documents, perform optical character recognition of the electronic scan documents, extract information from the electronic scan documents, deliver the electronic scan documents to recipients, store the electronic scan documents, etc.

Another exemplary method herein similarly receives envelopes containing sheets of media, removes the sheets of media from the envelopes, and stacks the sheets of media to produce groups of the sheets of media. This method also places an envelope on a corresponding group of the sheets of media that were within the envelope when the envelope was received. This process of stacking the groups of the sheets of media and placing the envelope on the groups of the sheets of media is repeated to create stacks of documents. These stacks of documents are then combined into bigger stacks to produce at least one batch scan job.

This exemplary method then scans the envelopes and the sheets of media in the batch scan job through an optical scanner (that can have a sheet feeder). This method also uses the envelopes as separator sheets between the groups of the sheets of media. Thus, during the batch scanning process, each envelope is followed by a corresponding group of sheets of media that were within the envelope when the envelope was received. The exterior of each envelope comprises classification data that classifies the corresponding group of sheets of media. The method can perform a scan of each the batch scan job in a single scan operation, without pausing between the stacks of documents.

This automatically produces electronic scan documents of scans of the groups of sheets separated according to the envelopes that act as the separator sheets. This method further automatically provides the electronic scan documents and the classification data to an electronic records system uses a computerized device. The electronic records system automatically processes the electronic scan documents using the classification data.

An exemplary system herein comprises an optical scanner, a computerized device operatively connected to the optical scanner, and an electronic records system that operates on the computerized device. As discussed above, after being removed from envelopes, the sheets of media are stacked into groups of the sheets of media, an envelope is placed on a corresponding group of sheets of media that were within the envelope. The optical scanner scans the envelopes and the groups of the sheets of media. During the scans, each the envelope is followed by the corresponding group of the sheets of media that were within the envelope. Therefore, the optical scanner uses the envelopes as separator sheets between the groups of the sheets of media when performing the scans.

The exterior of each the envelope comprises classification data that is used to classify the corresponding group of sheets of media that follow. The optical scanner and/or the computerized device automatically produce electronic scan documents of scans of the groups of the sheets separated according to the envelopes that act as the separator sheets. The computerized device automatically provides the electronic scan documents and the classification data to the electronic records system. The electronic records system automatically processes the electronic scan documents using the classification data.

Another exemplary system herein includes an optical scanner having a sheet feeder, a computerized device operatively connected to the optical scanner, and an electronic records system that operates on the computerized device. In this embodiment, specialized envelopes are included that have a size capable of being scanned by the optical scanner, and have at least one compartment sized to contain sheets of media. The specialized envelopes are all one size that is optimized to work in batch scan processing, yet is still capable of holding the necessary sheets that are to be scanned.

After being removed from the envelopes, the sheets of media are again stacked into groups, and an envelope is placed on a corresponding group of the sheets of media that were within the envelope. Again, the stacking of the groups of sheets of media and the placing of the envelope is repeated to create stacks of documents, and such stacks of documents are combined in to larger stacks to produce at least one batch scan job. The optical scanner automatically feeds the envelopes and the sheets of media in the batch scan job using the sheet feeder to scan the envelopes and the sheets of media.

During the scans each envelope is followed by a corresponding group of sheets of media that were within the envelope. Thus, the optical scanner uses the envelopes as separator sheets between the groups of the sheets of media when scanning the envelopes and the sheets of media. Because a sheet feeder is used, the optical scanner can automatically performs a scan of each the entire batch scan job in a single scan operation, without pausing between the individual stacks of documents that are in the batch scan job.

Again, the exterior of each envelope comprises classification data that is used to classify the corresponding group of the sheets of media. The optical scanner and/or the computerized device automatically produce electronic scan documents of scans of the groups of the sheets separated according to the envelopes act as the separator sheets. The computerized device automatically provides the electronic scan documents and the classification data to the electronic records system, and the electronic records system automatically processes the electronic scan documents using the classification data.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic diagram illustrating an exemplary workflow provided by the systems and methods herein;

FIG. 2 is a flow diagram illustrating an exemplary processes of the systems and methods herein;

FIG. 3 is a flow diagram illustrating an exemplary processes of the systems and methods herein;

FIG. 4 is a side-view schematic diagram of a device according to embodiments herein;

FIG. 5 is a side-view schematic diagram of a device according to embodiments herein; and

FIG. 6 is a side-view schematic diagram of a device according to embodiments herein.

### DETAILED DESCRIPTION

As mentioned above, small and medium businesses cannot afford expensive solutions for their incoming mail. Many computerized electronic record system support some form of network scanning and create a network scan template that will transmit electronic documents directly into the computerized electronic record system. Different computerized electronic record systems offer varying levels of sophistication for handling digital documents, however.

In view of these issues, the systems and methods herein process batch jobs of documents for scanning using the envelopes in which the documents arrived as document separators. Most common envelopes are detectable, can be fed through most document feeders, and contain valuable information (such as the sender and intended recipient of the mail). The systems and methods herein detect the envelope, extract any valuable information, and then add pages to the document until the next envelope is detected. The individual documents are then routed to the computerized electronic record system (with the extracted metadata from the envelope embedded or sent separately).

Such systems and methods allow document managers to batch scan any number of multi-page documents as part of a single, larger job. Instead of routing the scans directly to the computerized electronic record system, the electronic scan documents can be redirected to a service that separates the batch into individual documents before directing them into the computerized electronic record system.

The systems and methods herein produce time savings, thereby allowing the document manager to spend more time on value add tasks. Further, these systems and methods leveraging existing, open computerized electronic record system protocols that already exist to enable scanners to transmit electronic documents (e.g. TIFF or PDF) directly into the computerized electronic record system, so no changes in the proprietary software is needed.

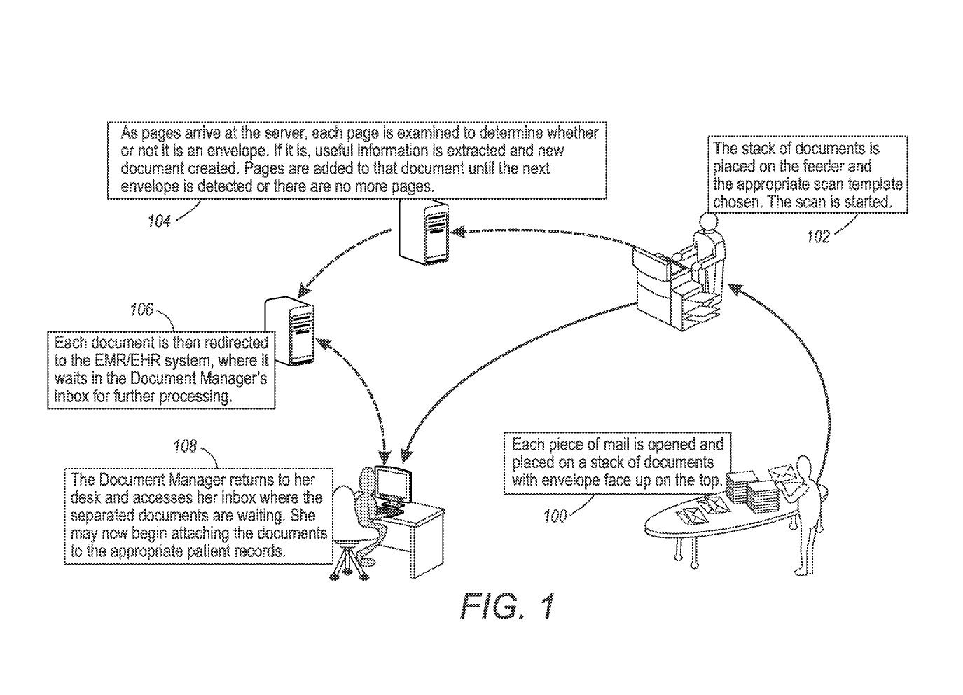

As an introductory example, FIG. 1 is a schematic diagram illustrating an exemplary workflow provided by the systems and methods herein. More specifically, in item 100 in FIG. 1, a front office staff opens hard copy mail as it arrives and places into the appropriate inbox with the envelope face up on the top of each document. After some delay, in item 102, the document manager retrieves the mail from her inbox as a single, large stack and the stack is loaded into the document feeder as a single, monolithic batch. In item 102, the document manager selects the appropriate single page network scan template and the document manager initiates the scan.

Next, in item 104, as scanned pages arrive at the server, each page is examined to determine whether or not it is an envelope. If it is an envelope, useful information is extracted from the marks on the exterior of the envelope (name, address, etc.) and a new document is created. In item 104, pages are added to each document until the next envelope is detected, or there are no more pages.

Following this, in item 106, each document is then redirected to the computerized electronic record system, where it waits in the document manager's inbox for further processing. As shown in item 108, the document manager can then return to their desk and access the inbox where the separate documents are waiting. The document manager may now begin attaching the documents to the appropriate patient records (in the medical records example presented in Figure presented in FIG. 1) or such attaching/matching can be automated.

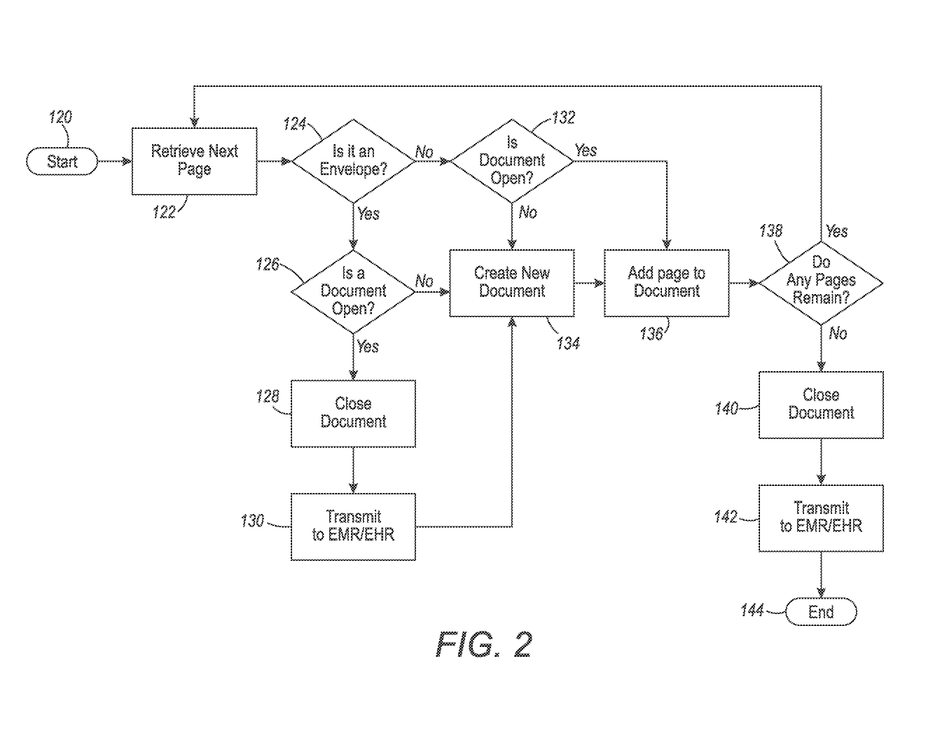

This processing is also shown in flowchart form in FIG. 2. More specifically, processing starts in item 120. In item 122 the first (or next) page is received from the scanner. Item 124 determines whether the last scanned page is an envelope. If it is an envelope, this indicates the beginning of a new document, therefore in item 126 the methods and systems herein determine whether there is already an open document. If there is already an open document, the previous document needs to be closed out and saved. Therefore, in item 128 the systems and methods herein close the document and, in item 130, transmit the closed document to the computerized electronic record system (again in this example, an EMR/EHR system).

To the contrary, if it is determined in item 126 that a document is not open, a new document is created in item 134 and pages are added to the new document in item 136. Also, in item 124 if the most recently scanned page is not an envelope processing proceeds to item 132, which determines whether there is already a document open. If a document is already open, processing proceeds to item 136 to add that page to the open document. Otherwise, processing again proceeds to item 134 to create a new document before adding the scanned page to the open document in item 136.

If there are still pages remaining to be scanned, item 138 returns processing to item 122. Otherwise, processing moves to item 140 where the open document is closed. Next, in item 142, the closed document is transmitted to the computerized electronic record system (again in this example, an EMR/EHR system). This exemplary process completes processing as shown in item 144.

Note, the following about the exemplary flows shown above. Envelopes have a very predictable format/layout and are detectable based on a few characteristics including a low information-to-white space ratio and predictable information locations. In the systems and methods herein, the document detection and separation features can exist within the same network as the computerized electronic record system (though not necessarily the same network as the scanner, which could be configured to send scanned images, for example, through a firewall). This permits scanned documents to be routed from the service to the computerized electronic record system without requiring a change to the proprietary computerized electronic record system code.

As another option, the systems and methods herein can run on the same network as the computerized electronic record system, which can “polls” the systems and methods herein for newly scanned documents before downloading the documents and redirecting them to the computerized electronic record system. The methods and systems herein are fully cloud computing capable, where scanned documents are redirected from a cloud/internet based service into the computerized electronic record system with the appropriate credentials.

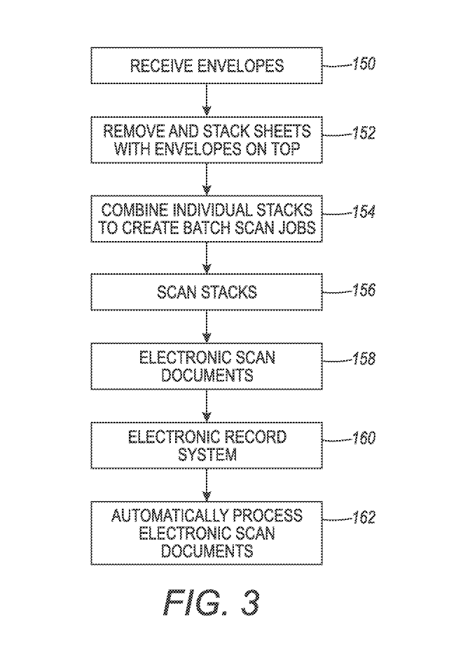

FIG. 3 is flowchart illustrating an exemplary method herein. In item 150, this exemplary method or workflow receives envelopes containing sheets of media (such as printed paper, letters, lab reports, bills, pictures; transparencies, such as X-rays, etc., and any other item capable of being placed in an envelope, all of which are referred to herein as “sheets of media” for shorthand convenience).

In item 152, the sheets of media are removed from the envelopes and stacked to produce groups of the sheets of media. In item 152, this method also places an envelope on a corresponding group of the sheets of media that were within the envelope when the envelope was received.

In item 154, this process of stacking the groups of the sheets of media and placing the envelope on the groups of the sheets of media is repeated to create stacks of documents, and these individual stacks of documents can be then combined into bigger stacks to produce at least one batch scan job. By preparing the scan batch jobs in this manner, the method and systems herein use the envelopes as separator sheets between groups of the sheets of media, avoiding the need for additional specialized separator sheets (and allowing the information already printed on the envelopes to categorize the sheets positioned below the envelopes in the batch stack). Batch processing is not required and, therefore, item 154 can be omitted in some processing.

Most common envelopes have a size capable of being processed through a document feeder and can be scanned by the optical scanner. As noted above, envelopes have a very predictable format/layout and are detectable based on a few characteristics including a low information-to-white space ratio (e.g., below 10%, below 5%, below 1%, etc.) and predictable information locations (sender address in upper left corner, recipient address in center, postage in upper right corner, etc.). In addition, automated postage markings often have specific characteristics (glyphs, colors, font types, etc.) which allow them to be recognized by a scanning system. Further, envelopes are generally limited to specific sizes. The systems and methods herein analyze the scanned image to detect such characteristics (and others) to automatically distinguish the envelopes from the other scanned sheets (again avoiding the need for additional specialized separator sheets). Thus, many embodiments herein do not require the user to perform any other pre-scan action than stacking the sheets to be scanned below the envelopes in which the sheets arrived. No separator sheets need to be stocked or inserted into the stack.

In alternative embodiments, each envelope can have a unique marking that can be added to the exterior (through stamping, stickers, etc.) that identifies the envelope as a separator sheet. Alternatively, especially for internal use, specialized potentially reusable folder envelopes (such as traditional intra-office mailers) can be used with the systems and methods herein. Such specialized folders can have pre-printed markings (which can be computer-readable markings) that allow the systems and methods herein to recognize them also as separator sheets. Alternatively, offices can request mailings that use specialized envelopes.

This exemplary method then scans the envelopes and the sheets of media in the batch scan job through an optical scanner (that can have a sheet feeder) in item 156. This method also uses the envelopes as separator sheets between the groups of the sheets of media. Thus, during the scanning process in item 156, each envelope is followed by a corresponding group of sheets of media that were within the envelope when the envelope was received. In item 156, the method can perform a scan of each the batch scan job in a single scan operation, without pausing between the stacks of documents.

This exemplary method thus automatically produces electronic scan documents (shown in item 158) of scans of the groups of sheets separated according to the envelopes that act as the separator sheets. Thus, each of the electronic scan documents comprises a scan of a different one of the groups of the sheets of media. The electronic scan documents and the classification data can then be automatically provided to an electronic records system using a computerized device, as shown in item 160.

The electronic records system can then automatically process the electronic scan documents using the classification data in item 162. As noted above, the exterior of each envelope comprises data (such as addresses, names, computerized markings that may contain dates, etc.) that can be recognized using conventional optical character recognition (OCR) processing. Such data can be used to automatically classify the corresponding group of the sheets of media that were positioned below the envelope in the stack. This classification data can, for example, comprises handwritten, typed, or printed marks on the exterior of the envelopes. Thus, in item 162 the client, patient, or subject matter name could be automatically identified from the return address and the electronic scan documents could be automatically routed to that client, patient, or subject matter's electronic record location. Then, any additional processing can occur, such as keeping statistics from the scanned data, e-mailing reports according to previously established methods, etc. Thus, in item 162, the electronic records system can use the classification data found on the exterior of the envelop to sort the electronic scan documents, perform optical character recognition of the electronic scan documents, extract information from the electronic scan documents, deliver the electronic scan documents to recipients, store the electronic scan documents, etc.

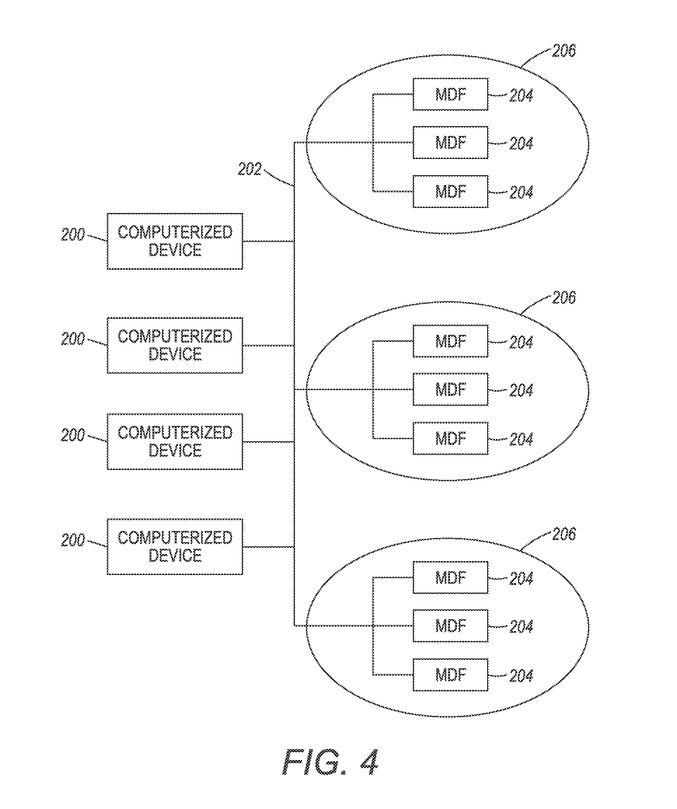

As shown in FIG. 4, exemplary system embodiments herein include various computerized devices 200, 204 located at various different physical locations 206. The computerized devices 200, 204 can include print servers, printing devices, personal computers, etc., and are in communication (operatively connected to one another) by way of a local or wide area (wired or wireless) network 202.

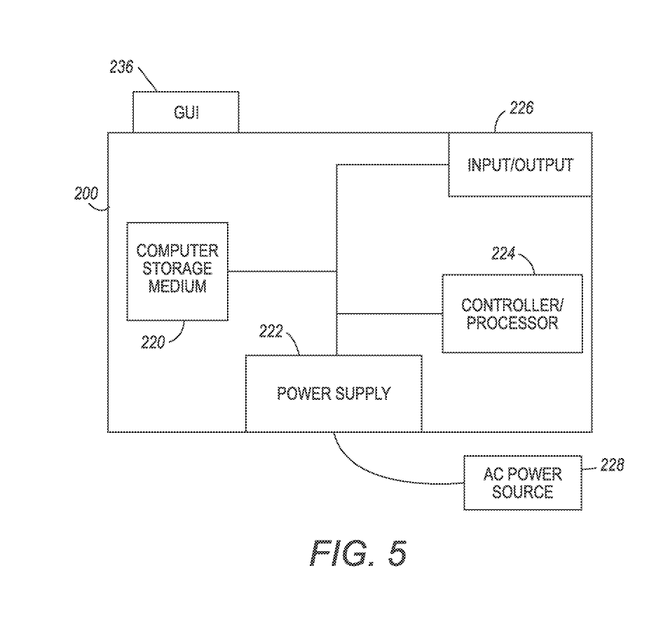

FIG. 5 illustrates a computerized device 200, which can be used with embodiments herein and can comprise, for example, a print server, a personal computer, a portable computing device, etc. The computerized device 200 includes a controller/processor 224 and a communications port (input/output) 226 operatively connected to the processor 224 and to the computerized network 202 external to the computerized device 200. Also, the computerized device 200 can include at least one accessory functional component, such as a graphic user interface assembly 236 that also operate on the power supplied from the external power source 228 (through the power supply 222).

The input/output device 226 is used for communications to and from the computerized device 200. The processor 224 controls the various actions of the computerized device. A non-transitory computer storage medium device 220 (which can be optical, magnetic, capacitor based, etc.) is readable by the processor 224 and stores instructions that the processor 224 executes to allow the computerized device to perform its various functions, such as those described herein. Thus, as shown in FIG. 5, a body housing 200 has one or more functional components that operate on power supplied from the alternating current (AC) 228 by the power supply 222. The power supply 222 can comprise a power storage element (e.g., a battery) and connects to an external alternating current power source 228 and converts the external power into the type of power needed by the various components.

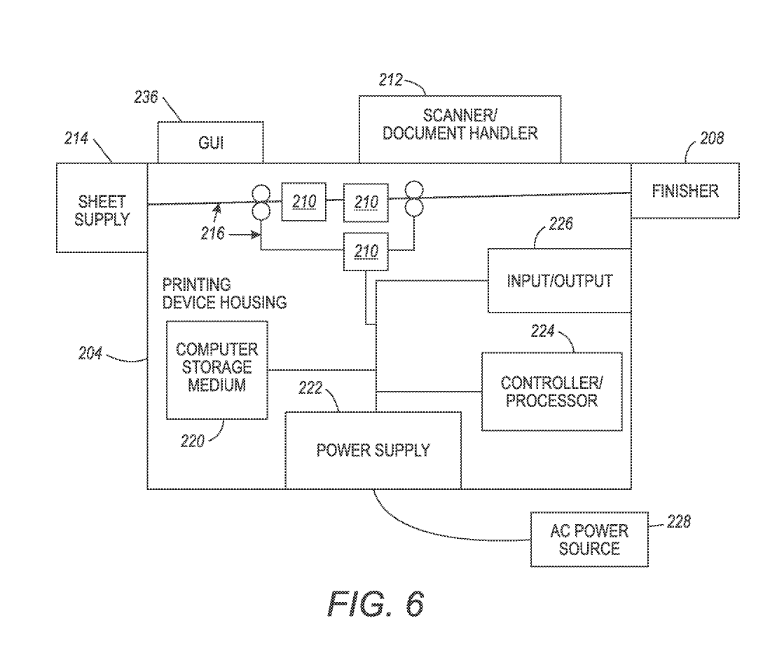

FIG. 6 illustrates a computerized device that is a printing device 204, which can be used with embodiments herein and can comprise, for example, a printer, copier, multi-function machine, multi-function device (MDF), etc. The printing device 204 includes many of the components mentioned above and at least one marking device (printing engines) 210 operatively connected to the processor 224, a media path 216 positioned to supply sheets of media from a sheet supply 214 to the marking device(s) 210, etc. After receiving various markings from the printing engine(s), the sheets of media can optionally pass to a finisher 208 which can fold, staple, sort, etc., the various printed sheets. Also, the printing device 204 can include at least one accessory functional component (such as a scanner/document handler 212, etc.) that also operates on the power supplied from the external power source 228 (through the power supply 222).

Thus, exemplary systems herein, such as those shown in FIGS. 4-6 include an optical scanner having a sheet feeder 212, a computerized device 224 operatively connected to the optical scanner 212, and an electronic records system that operates on the computerized device 224. In such embodiments, after being removed from the envelopes, the sheets of media are stacked into groups, and an envelope is placed on top of a corresponding group of the sheets of media that were within the envelope. For batch processing, the stacking of the groups of sheets of media and the placing of the envelope is repeated to create stacks of documents, and such stacks of documents are combined in to larger stacks to produce at least one batch scan job. The optical scanner 212 automatically feeds the envelopes and the sheets of media in the batch scan job using the sheet feeder to scan the envelopes and the sheets of media.

During the scans each envelope is followed by a corresponding group of sheets of media that were within the envelope. Thus, the optical scanner 212 uses the envelopes as separator sheets between the groups of the sheets of media when scanning the envelopes and the sheets of media. Because a sheet feeder is used, the optical scanner 212 can automatically perform a scan of each entire batch scan job in a single scan operation, without pausing between the individual stacks of documents that are in the batch scan job.

Again, the exterior of each envelope comprises classification data that is used to classify the corresponding group of the sheets of media. The optical scanner 212 and/or the computerized device 224 automatically produce electronic scan documents of scans of the groups of the sheets separated according to the envelopes act as the separator sheets. The computerized device 224 automatically provides the electronic scan documents and the classification data to the electronic records system, and the electronic records system automatically processes the electronic scan documents using the classification data.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004 (of which the limited portion relating to the description of a general printing device is incorporated herein by reference). The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the embodiments herein cannot be implied or imported from any above example as limitations to any particular order, number, position, size, shape, angle, color, or material.

What is claimed is:

1. A method comprising:
receiving envelopes containing sheets of media;
removing said sheets of media from said envelopes;
scanning said envelopes and said sheets of media through an optical scanner using said envelopes as separator sheets between groups of said sheets of media, during said scanning each said envelope is followed by a corresponding group of said sheets of media that were within said envelope when said envelope was received, and an exterior of each said envelope comprising classification data classifying said corresponding group of said sheets of media;
automatically producing electronic scan documents of scans of said groups of said sheets separated according to said envelopes acting as said separator sheets using a computerized device operatively connected to said optical scanner;
automatically providing said electronic scan documents and said classification data to an electronic records system using said computerized device; and
automatically processing said electronic scan documents using said classification data, using said electronic records system.

2. The method according to claim 1, each of said electronic scan documents comprising a scan of a different one of said groups of said sheets of media.

3. The method according to claim 1, each said envelope comprising a unique marking on said exterior identifying said envelope as a separator sheet.

4. The method according to claim 1, said processing comprising, based on said classification data, at least one of sorting said electronic scan documents, performing optical character recognition of said electronic scan documents, extracting information from said electronic scan documents, delivering said electronic scan documents to recipients, and storing said electronic scan documents.

5. The method according to claim 1, said classification data comprising markings on said exterior of said envelopes.

6. The method according to claim 1, said envelopes having a size capable of being scanned by said optical scanner.

7. A method comprising:
receiving envelopes containing sheets of media;
removing said sheets of media from said envelopes;
stacking said sheets of media to produce groups of said sheets of media;
placing an envelope on a corresponding group of said sheets of media that were within said envelope when said envelope was received;
repeating said stacking of said groups of said sheets of media and said placing of said envelope to create stacks of documents; and
combining said stacks of documents to produce a batch scan job,
scanning said envelopes and said sheets of media in said batch scan job through an optical scanner having a sheet feeder using said envelopes as separator sheets between said groups of said sheets of media, during said scanning each said envelope is followed by said corresponding group of said sheets of media that were within said envelope when said envelope was received, an exterior of each said envelope comprising classification data classifying said corresponding group of said sheets of media, and said scanning performing a scan of each said batch scan job in a single scan operation, without pausing between said stacks of documents;
automatically producing electronic scan documents of scans of said groups of said sheets separated according to said envelopes acting as said separator sheets using a computerized device operatively connected to said optical scanner;
automatically providing said electronic scan documents and said classification data to an electronic records system using said computerized device; and
automatically processing said electronic scan documents using said classification data, using said electronic records system.

8. The method according to claim 7, each of said electronic scan documents comprising a scan of a different one of said groups of said sheets of media.

9. The method according to claim 7, each said envelope comprising a unique marking on said exterior identifying said envelope as a separator sheet.

10. The method according to claim 7, said processing comprising, based on said classification data, at least one of sorting said electronic scan documents, performing optical character recognition of said electronic scan documents, extracting information from said electronic scan documents, delivering said electronic scan documents to recipients, and storing said electronic scan documents.

11. The method according to claim 7, said classification data comprising markings on said exterior of said envelopes.

12. The method according to claim 7, said envelopes having a size capable of being scanned by said optical scanner.

13. A system comprising:
an optical scanner;
a computerized device operatively connected to said optical scanner; and
an electronic records system operating on said computerized device;
after being removed from envelopes, sheets of media being stacked into groups of said sheets of media, an envelope being placed on a corresponding group of said sheets of media that were within said envelope,
said optical scanner scanning said envelopes and said groups of said sheets of media,
said optical scanner using said envelopes as separator sheets between said groups of said sheets of media when performing said scanning,
during said scanning, each said envelope is followed by said corresponding group of said sheets of media that were within said envelope,
an exterior of each said envelope comprising classification data classifying said corresponding group of said sheets of media,
said optical scanner and said computerized device automatically producing electronic scan documents of scans of said groups of said sheets separated according to said envelopes acting as said separator sheets,
said computerized device automatically providing said electronic scan documents and said classification data to said electronic records system, and
said electronic records system automatically processing said electronic scan documents using said classification data.

14. The system according to claim 13, each of said electronic scan documents comprising a scan of a different one of said groups of said sheets of media.

15. The system according to claim 13, each said envelope comprising a unique marking on said exterior identifying said envelope as a separator sheet.

16. The system according to claim 13, said processing by said electronic records system comprising, based on said classification data, at least one of sorting said electronic scan documents, performing optical character recognition of said electronic scan documents, extracting information from said electronic scan documents, delivering said electronic scan documents to recipients, and storing said electronic scan documents.

17. The system according to claim 13, said classification data comprising markings on said exterior of said envelopes.

18. The system according to claim 13, said envelopes having a size capable of being scanned by said optical scanner.

19. A system comprising:
an optical scanner having a sheet feeder;
a computerized device operatively connected to said optical scanner;
an electronic records system operating on said computerized device; and
envelopes having a size capable of being scanned by said optical scanner, and having at least one compartment sized to contain sheets of media,
after being removed from said envelopes, said sheets of media being stacked into groups of said sheets of media, an envelope being placed on a corresponding group of said sheets of media that were within said envelope,
stacking of said groups of said sheets of media and placing of said envelope being repeated to create stacks of documents, said stacks of documents being combined to produce a batch scan job,
said optical scanner automatically feeding said envelopes and said sheets of media in said batch scan job using said sheet feeder to scan said envelopes and said sheets of media,
said optical scanner using said envelopes as separator sheets between said groups of said sheets of media when scanning said envelopes and said sheets of media,
during said scanning each said envelope is followed by said corresponding group of said sheets of media that were within said envelope,
an exterior of each said envelope comprising classification data classifying said corresponding group of said sheets of media,
said optical scanner and said computerized device automatically producing electronic scan documents of scans of said groups of said sheets separated according to said envelopes acting as said separator sheets,
said computerized device automatically providing said electronic scan documents and said classification data to said electronic records system, and
said electronic records system automatically processing said electronic scan documents using said classification data.

20. The system according to claim 19, each of said electronic scan documents comprising a scan of a different one of said groups of said sheets of media.

21. The system according to claim 19, each said envelope comprising a unique marking on said exterior identifying said envelope as a separator sheet.

22. The system according to claim 19, said processing by said electronic records system comprising, based on said classification data, at least one of sorting said electronic scan documents, performing optical character recognition of said electronic scan documents, extracting information from said electronic scan documents, delivering said electronic scan documents to recipients, and storing said electronic scan documents.

23. The system according to claim 19, said classification data comprising markings on said exterior of said envelopes.

24. The system according to claim 19, said envelopes having a size capable of being scanned by said optical scanner.
